(19) United States
(12) Patent Application Publication
(10) Pub. No.: US 2004/0060420 A1
(43) Pub. Date: Apr. 1, 2004

(54) Harp pick

(76) Inventor: Patricia Elizabeth Masri - Fletcher, Novi, MI (US)

Correspondence Address: Patricia Masri - Fletcher, Petite Pig Productions, P.O. Box 263, Novi, MI, 48376, US

(21) Appl. No.: 10/665,311

(22) Filed: Sep. 20, 2003

Related U.S. Application Data
(60) Provisional application No. 60/412,199, filed on Sep. 20, 2002.

(51) Int. Cl. G10D 3/16

(52) U.S. Cl. 84/322

(57) ABSTRACT

The HARP PICK is made of a particular white, planar, compressed (as opposed to a woven), semi-stiff wool felt, approximately ¼ inch thick. The pick is cut from the felt by a metal die. Dimensions are typically 2 inches by 1 5/16 inches, however, slightly larger or smaller dimensions may apply. (See Diagram A of Drawings). An egg shape is proposed herein, however, other geometries may apply within the proposed dimensions, such as elongated or plump oval.

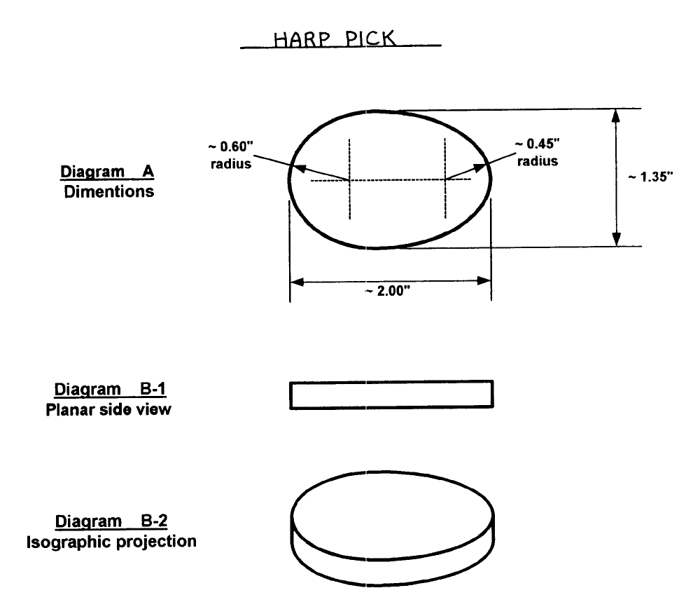

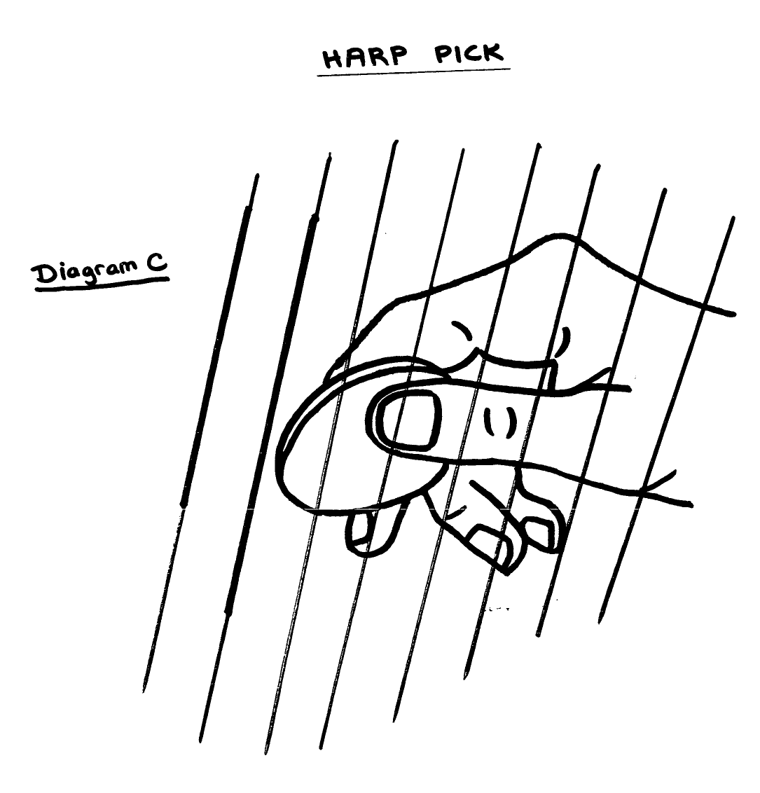

### BACKGROUND CROSS-REFERENCE TO RELATED APPLICATION

This application is entitled to the benefit of Provisional Patent Application Serial NO. 60/412,199, filed Sep. 20, 2002

### BACKGROUND OF THE INVENTION

1. Field of the Invention

The Present invention relates to a hand held device, which, when used, facilitates setting the strings of a harp in vibratory motion in an effect known as a “glissando” (a perpendicular sliding or gliding sweep across the strings).

2. Description of the Prior Art

A number of different devices have been used to facilitate the glissando. These have been used to produce greater volume for this effect especially in orchestral settings, where competition to be heard amongst the other instruments on stage becomes foremost. Guitar picks, U.S. 50 cent pieces, erasers, and various pieces of plastic, have all been tried. Some other felt type picks have been tried, and some even marketed as harp glissandi picks, however, all have been found to be inadequately small, not easily grasped, too thin, easily worn out, poorly shaped, or constructed of a material detrimental to the harp strings themselves. Although the known devices have some utility for their intended purposes, a need still exists in the art for a larger, felt harp pick specifically novel in size, thickness, and material, for the glissando in the orchestral setting.

### SUMMERY OF THE INVENTION

The present invention provides an apparatus for use in facilitating the harp glissando, especially in the orchestral setting. Accordingly, it is the object and advantages of the present invention to provide a device which not only facilitates the glissando, thereby saving the harpists fingers from potential blisters, but which, when the glissando is produced, is pleasing to the ear. This is obviously important because sound is foremost in the musicians' art form. Some other advantages over any other known device for execution of the glissando include: no known wear on the harp strings themselves, more easily grasped than other picks, larger size so that while executing the glissando, the harpist doesn't scrape the back of his/her thumbnail on the strings, and the thickness and material of the present invention also adds to its useful life (durability).

For a more complete understanding of the present invention, the reader is referred to the following drawings and detailed description section.

### BRIEF DESCRIPTION OF THE DRAWINGS

Diagram A: Dimensions

Diagram B-1: Planar side view

Diagram B-2: Isographic projection

Diagram C: Shows in-use by harpist

### DETAILED DESCRIPTION OF THE INVENTION

The HARP PICK is a hand-held device used to facilitate a particular sonorous effect on the harp called a “glissando”. (Italian term meaning strumming or sliding across multiple strings in a sweeping motion.)

The HARP PICK, proposed herein, is uniquely sized to permit secure grasping between thumb and fingers of one hand. (See Diagram A). The HARP PICK is made of a particular white, planer, compressed, semi-stiff wool felt, approximately ¼ inch thick; dimensions are typically 2 inches by 1 5/16 inches, however slightly larger or smaller dimensions may apply. (See Diagrams B-1 and B-2). An egg shape is proposed herein, however, other geometries may apply within the proposed dimensions, such as elongated or plump oval. It is cut by means of a metal die.

Because of its unique size and material composition, the HARP PICK can be controlled successfully by the performer. (Two may be used, one in each hand, for uni-directional or bi-directional glissandi). When used by the performer in the glissando effect previously described, the HARP PICK gives the performer the ability to produce sonic effects whether strummed gently for a softer effect, or vigorously for a larger volume of sound.

The HARP PICK facilitates vigorous glissandi, but still retains an appealing sound—as opposed to any other device for setting the strings in vibratory motion. (See Diagram C).

Although the present invention has been described herein with respect to a limited number of preferred embodiments, the foregoing description is intended to be illustrative, and not restrictive. Those skilled in the art will realize that some modifications of the preferred embodiment could be made which would be operable. All such modifications, which are within the scope of the claims, are intended to be within the scope and spirit of the present invention.

Having thus described the invention, what is claimed is:

1. A HARP PICK. A hand held device of a particular size and thickness, comprised of compressed wool felt. It's primary function is to set the strings of a harp in motion, whereby facilitating that sonorous effect known as the “glissando”.
